(19) United States
(12) Patent Application Publication
(10) Pub. No.: US 2026/0256138 A1
(43) Pub. Date: Sep. 3, 2026

(54) ANTIBACTERIAL FIBER STRUCTURE AND METHOD FOR PRODUCING ANTIBACTERIAL FIBER STRUCTURE

(71) Applicant: OSAKA KASEI CO., LTD., Osaka (JP)

(72) Inventors: Kazuhiro HAYASHI, Osaka (JP); Osamu GOUSHI, Osaka (JP); Harumi ASAMI, Osaka (JP); Yasushi YAMAGAMI, Osaka (JP)

(73) Assignee: OSAKA KASEI CO., LTD., Osaka (JP)

(21) Appl. No.: 19/165,459

(22) PCT Filed: Mar. 6, 2024
(86) PCT No.: PCT/JP2024/008584

§ 371 Date: Sep. 15, 2025

(30) Foreign Application Priority Data
Mar. 17, 2023 (JP) 2023-043068

(51) Int. Cl. A01N 25/34; A01N 43/80; A01N 47/12; A01N 55/00; A01N 59/16; A01P 1/00; D06M 11/07; D06M 11/46; D06M 11/64; D06M 11/83; D06M 11/84; D06M 13/352; D06M 13/425; D06M 13/513; D06M 13/53; D06M 16/00; D06M 101/06; D06M 101/32; D06M 101/38

(52) U.S. Cl. CPC A01N 25/34; A01N 43/80; A01N 47/12; A01N 55/00; A01N 59/16; A01P 1/00; D06M 11/07; D06M 11/46; D06M 11/64; D06M 11/83; D06M 11/84; D06M 13/352; D06M 13/425; D06M 13/513; D06M 13/53; D06M 16/00; D06M 2101/06; D06M 2101/32; D06M 2101/38

(57) ABSTRACT

An antibacterial fiber structure having excellent antibacterial properties with washing durability is provided. The antibacterial fiber structure includes a synthetic fiber, wherein an isothiazole antibacterial agent (A) and at least one antibacterial agent (B) belonging to any of antibacterial agent groups (X1: organosilicon quaternary ammonium salt, X2: carbamic acid ester derivative, X3: silver antibacterial agent, X4: metal oxide) are immobilized to the fiber, and the isothiazole antibacterial agent (A) is contained in an amount of 0.01 to 0.2% by weight in the entire fiber structure.

### TECHNICAL FIELD

The present disclosure relates to an antibacterial fiber structure in which antibacterial properties are imparted to a fiber structure, and a method for producing an antibacterial fiber structure.

### BACKGROUND ART

With recent increasing awareness of hygiene and health, many daily textile products, such as clothing, towels, and bedding, with antibacterial and antifungal properties have been on the market. However, antibacterial agents are often difficult to chemically bind to fibers, so most textile products with antibacterial properties are simply made by attaching the antibacterial agent to the fiber surface by coating using a binder such as resin. Therefore, products with high antibacterial properties have a larger amount of binder used, which impairs fiber texture. In addition, when the textile product is washed repeatedly, the antibacterial agent tends to leave the fiber surface together with the binder, and thus the antibacterial properties tend to deteriorate each time the textile product is washed. It is also possible to initially include the antibacterial agent in fibers at a high concentration in anticipation of decrease in antibacterial properties due to washing, but the use of a high concentration of the antibacterial agent is undesirable because of the risk of skin irritation and fiber discoloration.

On the other hand, in some synthetic fibers on the market, antibacterial agents are kneaded into fibers themselves to be spun in order to achieve washing durability. However, there are very few antibacterial agents that can withstand such kneading and spinning temperatures (in the case of polyester, 300° C. or higher). In addition, inorganic antibacterial agents with high heat resistance do not bleed onto the fiber surface when enclosed in the synthetic fibers, resulting in insufficient antibacterial properties.

For example, JP-A-2005-154965 and JP-A-H11-335202 below disclose technologies that improve the washing durability of antibacterial properties by examining the composition of an antibacterial treatment agent for imparting an antibacterial agent to fibers.

### RELATED ART DOCUMENT

### Patent Document

PATENT DOCUMENT 1: JP-A-2005-154965
PATENT DOCUMENT 2: JP-A-H11-335202

### SUMMARY

### Problems to be Solved by the Disclosure

However, both of the technologies disclosed in JP-A-2005-154965 and JP-A-H11-335202 are based on the premise that the antibacterial agent is attached to fibers using a resin binder. Therefore, the technical problem described above still remains and solution to the problem is desired.

The present disclosure is made to solve such a problem and provides an antibacterial fiber structure that exhibits excellent antibacterial properties even with a low concentration of an antibacterial agent, has a lower risk of skin irritation and fiber discoloration, and exhibits excellent washing durability, as well as a method for producing an antibacterial fiber structure.

### Means for Solving the Problems

In order to solve the problem, the present disclosure has the following aspects [1] to [10].
[1] An antibacterial fiber structure comprising a synthetic fiber,
   wherein an isothiazole antibacterial agent (A), and
   at least one antibacterial agent (B) belonging to any of the following antibacterial agent groups X1 to X4 immobilized to the synthetic fiber,
   wherein the isothiazole antibacterial agent (A) is contained in an amount of 0.01 to 0.2% by weight in the entire fiber structure:
   X1: organosilicon quaternary ammonium salt
   X2: carbamic acid ester derivative
   X3: silver antibacterial agent
   X4: metal oxide excluding silver oxide.
[2] The antibacterial fiber structure according to [1], wherein the antibacterial fiber structure has an antibacterial activity value of 2.2 or more against both Staphylococcus aureus and Klebsiella pneumoniae as measured in accordance with JIS L1902:2015 after 10 times of home washing performed in accordance with JIS L0217-103.
[3] The antibacterial fiber structure according to [1] or [2], wherein the isothiazole antibacterial agent (A) is a benzoisothiazolin derivative.
[4] The antibacterial fiber structure according to any one of [1] to [3], wherein the organosilicon quaternary ammonium salt of X1 is n-octadecyldimethyl[3-(trimethoxysilyl)propyl]ammonium chloride.
[5] The antibacterial fiber structure according to any one of [1] to [4], wherein the carbamic acid ester derivative of X2 is 3-iodo-2-propynyl-N-butylcarbamate.
[6] The antibacterial fiber structure according to any one of [1] to [5], wherein the silver antibacterial agent of X3 is at least one of silver nitrate, silver chloride, silver sulfate, and silver oxide.
[7] The antibacterial fiber structure according to any one of [1] to [6], wherein the metal oxide of X4 is at least one of titanium oxide and zinc oxide.
[8]A method for producing the antibacterial fiber structure of any one of [1] to [7], the method comprising:
   impregnating a fiber structure including a synthetic fiber with an aqueous treatment liquid containing an isothiazole antibacterial agent (A), and
   at least one antibacterial agent (B) belonging to any of the following antibacterial agent groups X1 to X4, and
   performing thermal treatment at 90° C. or higher and 200° C. or lower to obtain a fiber structure in which the isothiazole antibacterial agent (A) and the antibacterial agent (B) are immobilized to the fiber:
   X1: organosilicon quaternary ammonium salt
   X2: carbamic acid ester derivative
   X3: silver antibacterial agent
   X4: metal oxide excluding silver oxide.
[9] The method for producing the antibacterial fiber structure according to [8], wherein the thermal treatment is a heating process at 100 to 200° C. under normal pressure.
[10] The method for producing the antibacterial fiber structure according to [8], wherein the thermal treatment is a heating process at 90 to 150° C. under pressure.

In the present disclosure, the expression “Y to Z” (Y and Z are each a given number) is intended to encompass “preferably more than Y” or “preferably less than Z” unless otherwise specified, in addition to the meaning of “Y or more and Z or less”.

### Effects of the Disclosure

Specifically, the antibacterial fiber structure according to the present disclosure has the synergistic effect of a combination of the isothiazole antibacterial agent (A) and the specific other antibacterial agent (B) and thus achieves excellent antibacterial properties even with a very low concentration at which the isothiazole antibacterial agent (A) alone could not achieve effective antibacterial properties. Thus, the antibacterial fiber structure has high quality with a low risk of skin irritation and fiber discoloration otherwise caused by the isothiazole antibacterial agent (A).

The other antibacterial agent (B) can also be used at a lower concentration than when used alone, because of the synergistic effect with the isothiazole antibacterial agent (A). This is advantageous in that any inconvenience (such as fiber discoloration and texture degradation) that occurs when more antibacterial agent (B) is added can be avoided.

In addition, in the present disclosure, since the isothiazole antibacterial agent (A) and the specific other antibacterial agent (B) are immobilized directly to the fiber without using a resin binder, the antibacterial fiber structure according to the present disclosure has excellent washing durability and maintains excellent antibacterial properties even after repeated washing.

With the method for producing an antibacterial fiber structure according to the present disclosure, the antibacterial fiber structure can be efficiently produced using a conventional fiber processing apparatus for dyeing or the like.

### BRIEF DESCRIPTION OF DRAWINGS

FIG. 1 is a schematic diagram illustrating a method for producing an antibacterial fiber structure according to an embodiment of the present disclosure.

FIG. 2 is a schematic diagram illustrating a method for producing an antibacterial fiber structure according to another embodiment of the present disclosure.

### EMBODIMENTS OF THE DISCLOSURE

Embodiments for carrying out the present disclosure will now be described in detail. It should be noted that the present disclosure is not limited to the following embodiments.

An antibacterial fiber structure according to the present disclosure has an isothiazole antibacterial agent (A) and a specific other antibacterial agent (B) immobilized to a fiber, and has excellent antibacterial properties because of the synergistic effect of their combination.

### <Fiber Structure>

First, examples of a fiber substrate of the fiber structure covered by the present disclosure include synthetic fibers obtained from synthetic resins such as polyester, polyamide, acrylic, and polyurethane resins, mixtures of synthetic resins with components other than synthetic resins (such as metal and inorganic substance), and composites and mixtures thereof. The fiber substrate may be natural fibers (including recycled fibers) such as cotton, hemp, rayon, wool, and silk. The fiber substrate may be blended fibers of the synthetic fibers and natural fibers described above.

Among the fiber substrates listed above, preferred are polyester fibers (including those made only of polyester fibers) made mainly of polyester resins such as polyethylene terephthalate, polytrimethylene terephthalate, polybutylene terephthalate, and polylactic acid resin, which are in particularly high demand as antibacterial processed products and are also subject to the washing durability problem, as well as mixtures of polyester fibers and other fibers (mixed fibers and blended fibers).

Exemplary forms of the fiber structure made of the above fiber substrate include yarn, string, rope, and fabric (woven, knitted, nonwoven). A textile product made by combining the fiber substrate with other materials (rubber cord and sewing thread for clothing, film, etc.) is also intended to be included in the “fiber structure” covered by the present disclosure. Examples of such a textile product include bedding (curtains, sheets, towels, comforter fabric, comforter cotton, mats, carpets, pillowcases, etc.), clothing (coats, suits, sweaters, blouses, shirts, underwear, hats, masks, socks, gloves, etc.), and uniforms (lab coats, work clothes, school uniforms, etc.).

Examples of a wide range of applications, in addition to home use, include nursing care sheets, shower curtains, car seats, seat covers, interior materials such as ceiling materials, tents, insect and bird nets, partition sheets, air conditioning filters, vacuum cleaner filters, masks, tablecloths, desk underlays, aprons, wallpaper, and wrapping paper. Other examples are medical supplies (medical beds, wheelchairs, sterile bags, sterile sheets, etc.) and hygiene products (bandages, cleaning brushes, disposable masks, etc.).

In particular, the antibacterial fiber structure according to the present disclosure has antibacterial properties with excellent washing durability and thus is suitable for application to linen supply goods (surgical gowns, lab coats, nightclothes, sheets, etc.) which are repeatedly washed and used in medical and nursing care facilities.

A combination of the isothiazole antibacterial agent (A) and the other specific antibacterial agent (B) is used as an antibacterial agent to be included in the fiber structure.

### <Isothiazole Antibacterial Agent (A)>

Examples of the isothiazole antibacterial agent (A) include isothiazolin derivatives and benzoisothiazolin derivatives. Examples of the isothiazolin derivatives include 2-methyl-4-isothiazolin-3-one, 2-butyl-4-isothiazolin-3-one, 4-(n-octyl)isothiazolin-3-one, 4-methyl-5-chloroisothiazolin-3-one, 4-methylisothiazolin-3-one, and 4,5-dichloro-4-cyclohexylisothiazolin-3-one.

Examples of the benzoisothiazolin derivatives include 1,2-benzoisothiazolin-3-one, 2-butyl-1,2-benzoisothiazolin-3-one, and 4,5-benzoisothiazolin-3-one.

These isothiazole antibacterial agents (A) can be used alone or in combination of two or more. Among these, it is preferable to use the benzoisothiazolin derivatives. In particular, it is preferable to use 1,2-benzoisothiazolin-3(2H)-one (hereinafter abbreviated as “BIT”) and 2-butyl-1,2-benzoisothiazolin-3(2H)-one (hereinafter abbreviated as “BBIT”). Among these, the use of the BIT is optimal.

### <Other Specific Antibacterial Agent (B)>

As the other specific antibacterial agent (B) used together with the isothiazole antibacterial agent (A), at least one antibacterial agent belonging to any of the following antibacterial agent groups X1 to X4 is used.
X1: organosilicon quaternary ammonium salt
X2: carbamic acid ester derivative
X3: silver antibacterial agent
X4: metal oxide (excluding silver oxides, the same applies below)

The organosilicon quaternary ammonium salt (X1) is a quaternary ammonium salt having a bond between silicon (Si) and an organic group in a molecule. In terms of effectiveness, it is preferable that the organosilicon quaternary ammonium salt has a long-chain alkyl group exhibiting lipophilic properties, for example, an alkyl group having 1 to 14 carbon atoms. The number of carbon atoms in the entire compound is preferably 1 to 42, and more preferably 10 to 30.

Examples of the organosilicon quaternary ammonium salt (X1) include dimethyl(octadecyl)[3-(trimethoxysilyl)propyl]ammonium salt, dimethyl(nonadecyl)[3-(trimethoxysilyl)propyl]ammonium salt, dimethyl(octadecyl)[3-(triethoxysilyl)propyl]ammonium salt, and dimethyl(nonadecyl)[3-(triethoxysilyl)propyl]ammonium salt.

Examples of the anion species that constitutes the salt with ammonium cations in the organosilicon quaternary ammonium salt (X1) include iodide, bromide, chloride, adipate, gluconate, propionate, and sulfonate. Among these, bromide or chloride is preferred.

One type of the organosilicon quaternary ammonium salt (X1) may be used alone or two or more types may be used in combination. Among these, n-octadecyldimethyl[3-(trimethoxysilyl)propyl]ammonium chloride (hereinafter abbreviated as “DOTPAC”) is particularly preferred in terms of effectiveness.

As the carbamic acid ester derivative (X2), 3-iodo-2-propynyl-N-butylcarbamate (hereinafter abbreviated as “IPBC”) is particularly preferred in terms of effectiveness.

Furthermore, examples of the silver antibacterial agent (X3) include silver nitrate, silver chloride, silver sulfate, and silver oxide. Among these, silver nitrate and silver chloride are preferred, and silver nitrate is particularly preferred in terms of effectiveness.

Examples of the metal oxide (X4) include titanium oxide and zinc oxide. Among these, titanium oxide is preferred in terms of effectiveness. The metal oxide (X4) may be used in the form of a complex of metal oxide and metal salt.

The combination of the isothiazole antibacterial agent (A) with at least one antibacterial agent (B) belonging to any of the antibacterial agent groups (X1) to (X4) provides excellent antibacterial properties, even with very low concentrations of these agents compared with when the antibacterial agents (A) and (B) are each applied alone to the fiber. This is the most important feature of the present disclosure.

In other words, when the isothiazole antibacterial agent (A) is used alone, effective antibacterial properties are not exhibited unless more than 0.2% by weight is contained in the entire fiber structure. However, with an amount 0.1% by weight or more, there is a risk that skin irritation may occur (from data as of Dec. 26, 2022, National Institute of Technology and Evaluation). In contrast, when the isothiazole antibacterial agent (A) is used in combination with the other specific antibacterial agent (B), excellent antibacterial properties are exhibited even when the isothiazole antibacterial agent (A) is in an amount of 0.2% by weight or less, especially less than 0.1% by weight.

In the present disclosure, therefore, the amount of the isothiazole antibacterial agent (A) in the entire fiber structure is set to 0.01 to 0.2% by weight. In this range, the combination of the isothiazole antibacterial agent (A) and the other specific antibacterial agent (B) can exhibit antibacterial properties because of a remarkable synergistic effect.

The antibacterial properties because of a remarkable synergistic effect of the above combination in the subject application are obtained presumably due to the following composite action. That is, the mechanism of antibacterial action of the isothiazole antibacterial agent (A) is protein synthesis system inhibition, cell membrane synthesis inhibition, thiol enzyme inhibition, and enzyme inhibition of TCA cycle, whereas the mechanism of antibacterial action of the organosilicon quaternary ammonium salt (X1) is cell membrane destruction and protein denaturation. The mechanism of antibacterial action of the carbamic acid ester derivative (X2) is mitosis inhibition and enzyme function inhibition, and the mechanism of antibacterial action of the silver antibacterial agent (X3) is protein denaturation and enzyme activity inhibition. Further, the mechanism of antibacterial action of the metal oxide (X4) is oxidative decomposition. In this way, combining the antibacterial agents that have mechanisms of antibacterial action completely different from each other is expected to produce a remarkable synergistic effect. In particular, even when acting on the same cell membrane, the combination of the isothiazole antibacterial agent (A), which inhibits cell membrane synthesis, and (X1), (X3), and (X4), which destroy the cell membrane itself, is expected to produce a more remarkable synergistic effect.

The composite mechanism of action described above is not limited to antibacterial properties, but is thought to have the same excellent effect on antifungal properties. Thus, excellent antifungal properties can be expected against mold as well.

In particular, (X1), (X3), and (X4) have excellent antibacterial properties due to their mechanisms of action, but are somewhat inferior in antifungal properties. Therefore, more antifungal properties can be expected by combining (X1), (X3), and (X4) with the isothiazole antibacterial agent (A) excellent in both antibacterial properties and antifungal properties.

In particular, when the isothiazole antibacterial agent (A) is used in combination with the organosilicon quaternary ammonium salt (X1) and/or the carbamic acid ester derivative (X2), the amount of the isothiazole antibacterial agent (A) in the entire fiber structure is preferably set to 0.025 to 0.1% by weight and more preferably set to 0.03 to 0.08% by weight.

In particular, when the isothiazole antibacterial agent (A) is used in combination with the silver antibacterial agent (X3) and/or the metal oxide (X4), the amount of the isothiazole antibacterial agent (A) in the entire fiber structure is preferably set to 0.015 to 0.08% by weight and more preferably set to 0.02 to 0.03% by weight.

On the other hand, excellent antibacterial properties are exhibited with a smaller amount of the other specific antibacterial agent (B) used in combination with the isothiazole antibacterial agent (A) in the entire fiber structure, compared with when the other specific antibacterial agent (B) is used alone. For example, among the other antibacterial agents (B), the organosilicon quaternary ammonium salt (X1) is preferably contained in an amount of 3% by weight or more in the entire fiber structure when attached alone to the fiber in order to obtain effective antibacterial properties. However, when combined with the isothiazole antibacterial agent (A), the organosilicon quaternary ammonium salt (X1) can sufficiently exhibit excellent antibacterial properties even at a concentration as low as, for example, about 0.5% by weight in the fiber structure. In this way, if the amount of the other antibacterial agent (B) can be kept at a very low concentration, material costs can be reduced. Some types of the antibacterial agent (B) have the risk of causing coloration, texture degradation, and the like of the fiber if their concentration is high. However, this risk can be avoided.

In this respect, when the organosilicon quaternary ammonium salt (X1) is used as the other antibacterial agent (B), the amount of the organosilicon quaternary ammonium salt (X1) in the entire fiber structure is preferably set to 0.4 to 3% by weight and more preferably 1 to 2% by weight. The content ratio [(X1)/(A)] of the organosilicon quaternary ammonium salt (X1) to the isothiazole antibacterial agent (A) is usually set to 5 to 200, preferably 15 to 60, and more preferably 20 to 40, on a weight basis.

Similarly, when the carbamic acid ester derivative (X2) is used as the other antibacterial agent (B), the amount of the carbamic acid ester derivative (X2) in the entire fiber structure is preferably set to 0.2 to 1.0% by weight and more preferably 0.3 to 0.8% by weight. The content ratio [(X2)/(A)] of the carbamic acid ester derivative (X2) to the isothiazole antibacterial agent (A) is usually set to 3.5 to 70, preferably 7 to 30, and more preferably 10 to 20, on a weight basis.

Similarly, when the silver antibacterial agent (X3) is used as the other antibacterial agent (B), the amount of the silver antibacterial agent (X3) in the entire fiber structure is preferably set to 0.0001 to 0.01% by weight and more preferably 0.0002 to 0.008% by weight. The content ratio [(X3)/(A)] of the silver antibacterial agent (X3) to the isothiazole antibacterial agent (A) is usually set to 0.004 to 0.4, preferably 0.02 to 0.32, and more preferably 0.04 to 0.2, on a weight basis.

Similarly, when the metal oxide (X4) is used as the other antibacterial agent (B), the amount of the metal oxide (X4) in the entire fiber structure is preferably set to 0.0001 to 0.02% by weight and more preferably 0.008 to 0.01% by weight. The content ratio [(X4)/(A)] of the metal oxide (X4) to the isothiazole antibacterial agent (A) is usually set to 0.004 to 0.8, preferably 0.01 to 0.4, and more preferably 0.03 to 0.3, on a weight basis.

The antibacterial fiber structure according to the present disclosure can be obtained by using an antibacterial agent that combines the isothiazole antibacterial agent (A) and the other antibacterial agent (B), for example, as follows.

### <Method for Producing Antibacterial Fiber Structure>

### (1) Preparation of Antibacterial Treatment Liquid

First, an antibacterial treatment liquid is prepared to impart antibacterial properties to the fiber structure. This antibacterial treatment liquid can be obtained by dissolving or dispersing two antibacterial agents (A) and (B) described above in a liquid that serves as a solvent or a dispersion medium.

Water is usually used as the liquid that serves as a solvent or a dispersion medium. Examples of the water include tap water, soft water, ion-exchanged water, pure water, and purified water. Preferably, soft water, ion-exchanged water, and purified water are suitably used. These may be used alone or may be used in combination of two or more.

An organic solvent can be used together with or instead of the water. Examples of the organic solvent include ethanol, acetone, ethyl acetate, hexane, ethanol, dichloromethane, tetrahydrofuran, diethyl ether, acetone, isopropanol, N,N-dimethylformamide, and dimethyl sulfoxide. These may be used alone or may be used in combination of two or more.

In addition to two essential antibacterial agents (A) and (B) described above, the antibacterial treatment liquid according to the present disclosure can be blended with known optional components such as fiber processing aid, dispersant, deodorant, antiseptic, fragrance, oil ingredient, thickener, moisturizer, pigment, pH adjuster, ceramides, sterols, antioxidant, singlet oxygen quencher, UV absorber, whitening agent, anti-inflammatory agent, other antibacterial agents, and antiviral agents as necessary in order to improve antibacterial properties and sustain the effect. These can be used alone or in combination of two or more.

The fiber processing aid is used according to the type of fiber in order to prevent abnormalities such as discoloration, hardening, and shrinkage of the fiber structure and to suppress reduction of antibacterial properties of the antibacterial agents (A) and (B). Examples of the fiber processing aid include antistatic agent, flame retardant, softener, fixer, antifoulant, dye retarding agent, fluorescent brightener, swelling agent, penetrating agent, emulsifier, metal chelator, dye leveling agent, anti-precipitation agent, anti-migration agent, carrier, anti-dyeing agent, anti-wrinkle agent, and texturing agent.

For example, when a blend of polyester fiber and natural fiber such as cotton, rayon, wool, or silk is processed or when a blend of polyester fiber and polyamide, acrylic, or polyurethane fiber is processed, depending on processing temperature and time, the fiber other than the polyester fiber may suffer abnormalities such as discoloration, hardening, and shrinkage due to the action of cations of the antibacterial agent (B) and the like, or the antibacterial properties may be reduced or lost.

Therefore, in order to prevent such a situation, it is preferable to use the fixer, dye leveling agent, dye retarding agent, fluorescent brightener and the like as the aid.

Examples of the fixer include polycationic compounds, polyamine compounds, phenolic compounds, and the like, which can be used as appropriate according to dye.

Examples of the dye leveling agent and the dye retarding agent include nonionic surfactants typified by alkyl ether type, polycyclic phenyl ether type, sorbitan derivatives, aliphatic polyether type, and the like, nonionic agents typified by salt cake, ammonium sulfate, and the like, cationic surfactants [excluding those used as the antibacterial agent (B)] typified by dodecyl triammonium salt, and anionic surfactants typified by sodium dialkyl succinate sulfonate, naphthalene sulfonate formalin condensate, and the like.

Examples of the fluorescent brightener include oxazole derivatives, stilbene derivatives, coumarin derivatives, and naphthalimide derivatives.

It is suitable to use the antistatic agent as the aid because if the fiber surface is charged, contact of the antibacterial agents (A) and (B) with bacteria may be electrically hindered. Examples of the antistatic agent include quaternary ammonium salt derivatives [excluding those used as the antibacterial agent (B)] and phosphate derivatives.

The antibacterial treatment liquid used in the present disclosure is obtained by dissolving or dispersing each of the above components in a liquid such as water or an organic solvent as described above, but the order in which the components are blended is not particularly limited. It is not necessary to mix all the components in one liquid. A first liquid containing the isothiazole antibacterial agent (A) and a second liquid containing the other specific antibacterial agent (B) can be prepared, and these two liquids can be mixed to form a homogeneous solution or dispersion. Furthermore, the optional components may also be blended in one liquid, or when two liquids are separately prepared as described above, the optional components may be blended in one of the first liquid and the second liquid, in consideration of the properties of optional components. Alternatively, a liquid containing only optional components may be prepared separately from the antibacterial agents (A) and (B) and mixed with one or two liquids containing the antibacterial agents (A) and (B) to finally obtain an antibacterial treatment liquid.

The antibacterial treatment liquid is usually not used in undiluted form, but is diluted at an appropriate ratio before being used to treat the fiber structure. The ratio of dilution of the antibacterial treatment liquid is usually adjusted based on how much antibacterial agents (A) and (B) are contained (which is called “% owf”) relative to the dry fiber weight of the fiber structure to be treated.

The amount of the isothiazole antibacterial agent (A) in the antibacterial fiber structure according to the present disclosure is set to be 0.01 to 0.2% by weight in the total antibacterial fiber structure, as already described. The amount of the other antibacterial agent (B) is adjusted as appropriate as described above.

A method for performing antibacterial treatment on the fiber structure using the antibacterial treatment liquid will now be described.

### (2) Antibacterial Treatment Method

The antibacterial treatment using the antibacterial treatment liquid is not limited to any particular method as long as the fiber structure is brought into sufficient contact with the antibacterial treatment liquid, and the antibacterial components (isothiazole antibacterial agent (A)+ other specific antibacterial agent (B)) in the antibacterial treatment liquid can be immobilized on the fiber surface and inside the fiber. For example, there are two methods: (1) a normal pressure treatment method and (2) a pressure treatment method. An appropriate method can be selected according to the type and form of the fiber. These treatment methods will be described briefly.

### (2-1) Normal Pressure Treatment Method

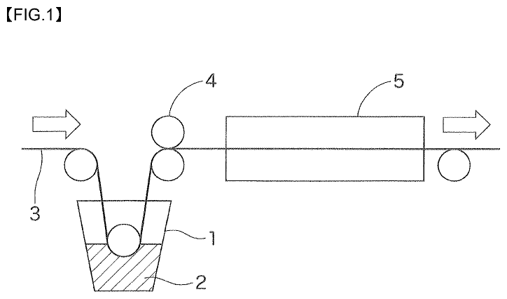

The normal pressure treatment method is a method in which the fiber structure is brought into contact with the antibacterial treatment liquid, and the fiber structure impregnated with the antibacterial treatment liquid is subjected to a heating process using an oven or the like. The fiber structure may be brought into contact with the antibacterial treatment liquid by a method such as spraying or coating the antibacterial treatment liquid on the fiber structure. However, in general, as schematically illustrated in FIG. 1, an antibacterial treatment liquid 2 is stored in a dipping tank 1, and a fiber structure 3 is immersed in the antibacterial treatment liquid 2 and squeezed at a predetermined squeeze rate using a mangle 4 or the like. This method is preferred because the amount of the antibacterial treatment liquid 2 applied to the fiber structure 3 is easily controlled. FIG. 1 shows a heating device 5 such as an oven. The antibacterial agent is then immobilized to the fiber structure by the heating process.

The method illustrated in FIG. 1 is basically the same configuration as a method called continuous treatment method, baking method, pad-dry-cure method, or the like in the dyeing field. Antibacterial treatment can be performed by using the antibacterial treatment liquid instead of (or in some cases, together with) a dyeing treatment liquid for dyeing.

The “normal pressure treatment” means that the treatment is performed without reducing pressure or increasing pressure and usually means treatment under atmospheric pressure (1013.25 hPa).

The heating temperature (temperature in the heating space for the fiber structure) in the heating process is usually 100 to 200° C., and the heating time is preferably 10 to 300 seconds. The heating temperature and the heating time are adjusted to suitable ranges as appropriate according to the type of fiber. For example, when the fiber structure is 100% polyester, the heating temperature is preferably 130 to 180° C. and the heating time is preferably 30 to 180 seconds.

### (2-2) Pressure Treatment Method

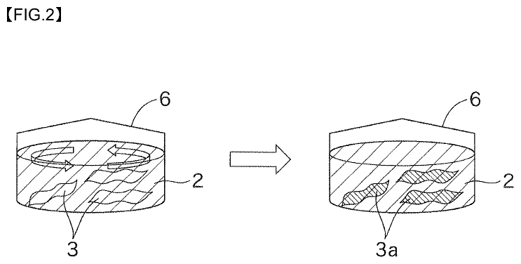

The pressure treatment method is a method for immobilizing the antibacterial agent to the fiber structure by putting the antibacterial treatment liquid 2 and the fiber structure 3 into a pressure vessel 6, and after sealing tightly, performing a heating process under pressure, as schematically illustrated in FIG. 2. The fiber structure 3a with the antibacterial agent immobilized is dewatered and dried.

The method illustrated in FIG. 2 is basically the same configuration as a method called cheese dyeing method, batch dyeing method, liquid flow dyeing method, or the like in the dyeing field. Antibacterial treatment can be performed by using the antibacterial treatment liquid instead of (or in some cases simultaneously with) a dye treatment liquid for dyeing.

The degree of pressure in the “pressure treatment” depends on the type of fiber and the like, but usually means treatment under pressure of about 5 to 200 kPa in terms of gauge pressure. For example, in the case of polyester fiber, it is preferable to treat the fiber under pressure of about 100 to 200 kPa in terms of gauge pressure.

The heating temperature in the treatment in a pressure vessel (temperature inside the pressure vessel) is usually 90 to 150° C., and the heating time is preferably 1 to 120 minutes. The heating temperature and the heating time are adjusted to suitable ranges as appropriate according to the type of fiber. For example, when the fiber structure is 100% polyester, the heating temperature is preferably 100 to 135° C. and the heating time is preferably 10 to 100 minutes.

### <Antibacterial Fiber Structure>

The antibacterial fiber structure according to the present disclosure can be obtained by the treatment described above. In the antibacterial fiber structure according to the present disclosure, the fiber is impregnated with the isothiazole antibacterial agent (A) and the other specific antibacterial agent (B) as the antibacterial treatment liquid, and heated in the impregnated state, so that the antibacterial agents (A) and (B) are immobilized in the spaces between molecules (amorphous regions loosened by heating) that constitute the fiber. Therefore, the bonding strength with the fiber is strong, and excellent washing durability is exhibited. Thus, unlike the conventional antibacterial agent attached to the fiber surface through a binder process, the antibacterial agent does not gradually drop off with the resin binder and rapidly lose its antibacterial properties.

Although it is possible to use the binder process in combination in the treatment of the present disclosure, the blended resin binder may, on the contrary, interfere with the direct bonding between the fiber and the antibacterial agents (A) and (B). Thus, when a resin binder is used, the amount of the resin binder used is preferably 5% by weight or less in the entire fiber structure, more preferably 1% by weight or less.

As already mentioned, the thus obtained antibacterial fiber structure according to the present disclosure has a synergistic effect of a combination of the isothiazole antibacterial agent (A) and the other antibacterial agent (B) so that the amount of these agents are set to be very small. Therefore, the risk of skin irritation and the risk of fiber discoloration and the like, which are likely to occur with a large amount of antibacterial agent, is suppressed, and a textile product not only with antibacterial properties but also with excellent quality can be provided.

Since there is no need to coat the fiber surface with a resin binder as in conventional products, the fiber does not have rough texture.

Examples of target bacteria on which the antibacterial fiber structure according to the present disclosure can exhibit antibacterial effects include gram-positive bacteria such as Staphylococcus aureus, MRSA (Methicillin-resistant taphylococcus aureus), Bacillus subtilis, and Bacillus cereus, and gram-negative bacteria such as Escherichia coli, Klebsiella pneumoniae, Salmonella typhimurium, and Pseudomonas aeruginosa.

In the present disclosure, a product is evaluated as “having antibacterial properties” when its antibacterial activity value is 2.2 or more against at least two of the above bacteria, Staphylococcus aureus and Klebsiella pneumoniae.

The “antibacterial activity value” can be measured as follows.

### <Method for Measuring Antibacterial Activity Value>

Measurement is performed using “Staphylococcus aureus” and “Klebsiella pneumoniae” as test species according to the method in accordance with JIS L1902:2015. More specifically, first, each test species is inoculated into each of a standard fabric (cotton cloth that does not exhibit antibacterial activity) and an antibacterial finished textile fabric, and the viable bacteria count of each fabric is measured after incubation at 37° C. for 18 to 24 hours. The antibacterial activity value is calculated from each of the measured viable bacterial counts according to the following calculation.

$$Antibacterial activity value A = ( Log Ct - Log Co ) - ( Log Tt - Log To )$$

$$Standard fabric growth value F = ( Log Ct - Log Co )$$

LogCo: the common logarithm of arithmetic mean of viable bacterial counts of three samples immediately after inoculation of the standard fabric with test bacteria.
LogCt: the common logarithm of arithmetic mean of viable bacterial counts of three samples after 18 hours of incubation on the standard fabric
LogTo: the common logarithm of arithmetic mean of viable bacterial counts of three samples immediately after inoculation of the antibacterial finished textile fabric with test bacteria
LogTt: the common logarithm of arithmetic mean of viable bacterial counts of three samples after 18 hours of incubation on the antibacterial finished fabric

If the antibacterial activity value is “2.2” or more, a product is evaluated as being “effective”, and if the antibacterial activity value is less than “2.2”, a product is evaluated as being “ineffective” (as specified by Japan Textile Evaluation Technology Council).

Another important feature of the antibacterial fiber structure according to the present disclosure is that the antibacterial properties have washing durability. In evaluation of the antibacterial properties, the antibacterial fiber structure according to the present disclosure is subjected to “10 times of home washing at 40° C.” or “50 times of home washing at 40° C.” in accordance with JIS L0217-103, and the antibacterial activity value of the fiber structure after washing is measured.

### EXAMPLES

Examples of the present disclosure will now be described along with comparative examples. It should be noted that the present disclosure is not limited to the following examples.

### [Preparation of Antibacterial Treatment Liquid]

First, an antibacterial treatment liquid having a composition shown in the tables below was prepared by dissolving or suspending the isothiazole antibacterial agent (A), the other antibacterial agent (B), and other optional components in water. The components and the fiber structures (fabrics) to be processed are as shown below.

### <Isothiazole Antibacterial Agent (A)>

BIT (Proxel LV available from Arxada)
BBIT (Densyl DG available from Arxada)

### <Other Antibacterial Agent (B)>

### (1) Organosilicon Quaternary Ammonium Salt (X1)

DOTPAC (AEM5700 available from AEGIS)

### (2) Carbamic Acid Ester Derivative (X2)

IPBC (Polyphase P100HP available from Troy Corporation)

### (3) Silver Antibacterial Agent (X3)

Silver nitrate
Silver chloride

### (4) Metal Oxide (X4)

Titanium oxide

### <Optional Components>

(1) Surfactant 1: N-alkylolamide (LEVENOL TD-881D available from Hokko Chemical Co., Ltd.)
(2) Binder 1: RIKEN RESIN MM-35 (available from Mikiriken Industrial Co., Ltd.)

### <Fiber Structure>

Fiber 1: Fabric made of polyester (100% PET Tropical available from TEIJIN LIMITED)
Fiber 2: Fabric made of polyester and cotton (50% PET, 50% cotton mixed woven, available from Shikisensha CO., LTD.)
Fiber 3: Nylon (nylon 6 jersey, available from Shikisensha CO., LTD.)
Fiber 4: Fabric made of polyurethane and polyester (15% polyurethane, 85% polyester mixed woven, available from Shikisensha CO., LTD.)
Fiber 5: Fabric made of cotton (shirting, available from Shikisensha CO., LTD.)

Using the treatment liquids and the fiber structures (fabrics made of fibers 1 to 5 above) prepared in this way, antibacterial treatment was performed under the conditions listed in Tables 1 to 11. The fabrics were removed from the container and washed with water overflowing in a washing machine for 5 minutes to remove excess components on the fiber surface, and then air-dried overnight to obtain desired antibacterial fiber structures.

The products of examples and comparative examples obtained by the antibacterial treatment were checked for changes in coloration, texture, and the like of the fibers by eye and by hand. In addition, the following items were evaluated according to the procedure described for each item.

### <Evaluation of Antibacterial Properties 1 and 2>

Each antibacterial fiber structure was subjected to “10 times of home washing at 40° C.” or “50 times of home washing at 40° C.” in accordance with JIS L0217-103. The antibacterial properties of the fiber structures after washing were evaluated according to the method described above according to the method in accordance with JIS L1902:2015, using Staphylococcus aureus as a test species for the evaluation of antibacterial property 1 and Klebsiella pneumoniae as a test species for the evaluation of antibacterial property 2.

### <Evaluation of Antifungal Properties>

Evaluation was made using “Penicillium citrinum” as a test species according to the method in accordance with JIS L1921:2015 and by measuring the amount of ATP contained in the fungus. More specifically, first, a liquid medium in which spores of the test species were suspended was inoculated into the obtained treated product and incubated at 25° C. for 42 hours. The amount of ATP after incubation was measured and compared with the same test value (amount of ATP) of untreated cotton fiber to obtain an antifungal activity value. If the antifungal activity value was “2.2” or more, a product was evaluated as being “effective”, and if the antifungal activity value was less than 2.2, a product was evaluated as being “ineffective” (as specified by Japan Textile Evaluation Technology Council).

### Examples 1 to 12, Comparative Examples 1 to 3

### <Combination of Antibacterial Agent (A) and Antibacterial Agent (B) X1>

The desired treated products were obtained by performing antibacterial treatment on the fiber structures under the treatment conditions listed in Tables 1 and 2 below. These products of Examples 1 to 12 and Comparative Examples 1 to 3 were evaluated as described above, and the results are listed in Tables 1 and 2 below.

TABLE 1

| | | | Comparative | Comparative | Comparative | | | | |
|---|---|---|---|---|---|---|---|---|---|
| | | | Example 1 | Example 2 | Example 3 | Example 1 | Example 2 | Example 3 | Example 4 |
| Type of fiber | | | Fiber 1 | Fiber 1 | Fiber 1 | Fiber 1 | Fiber 1 | Fiber 1 | Fiber 1 |
| Treatment | Type of processing | | Baking | Baking | Baking | Baking | Baking | Baking | Baking |
| conditions | Heating temperature(° C.) | | 180 | 180 | 180 | 180 | 180 | 180 | 180 |
| | Heating time (min) | | 1 | 1 | 1 | 1 | 1 | 1 | 1 |
| Amount | A | BIT | 0.05 | 2 | — | 0.01 | 0.025 | 0.03 | 0.05 |
| contained | | BBIT | — | — | — | — | — | — | — |
| (% by | X1 | DOTPAC | — | — | 0.8 | 1.5 | 1.5 | 1.5 | 1.5 |

| weight) * | Surfactant 1 | — | — | — | — | — | — | — |
|---|---|---|---|---|---|---|---|---|
| | Binder 1 | — | — | — | — | — | — | — |
| X1/A(Weight basis) | | — | — | — | 150 | 60 | 50 | 30 |
| Number of times of home | | 10 | 10 | 10 | 10 | 10 | 10 | 10 |
| washing at 40° C. | | | | | | | | |
| Evaluation | Change in appearance | None | Slightly yellow | None | None | None | None | None |
| result | and texture of fiber | | | | | | | |
| | Antibacterial property 1 | Ineffective | Effective | Effective | Effective | Effective | Effective | Effective |
| | (Staphylococcus aureus) | | | | | | | |
| | Antibacterial property 2 | Ineffective | Effective | Ineffective | Effective | Effective | Effective | Effective |
| | (Klebsiella pneumoniae) | | | | | | | |
| | Antifungal property | Ineffective | Ineffective | Ineffective | Effective | Effective | Effective | Effective |
| | (Penicillium citrinum) | | | | | | | |

* The amount of component contained in fiber structure (the same applies to the tables below)

TABLE 2

| | | | Example 5 | Example 6 | Example 7 | Example 8 | Example 9 | Example 10 | Example 11 | Example 12 |
|---|---|---|---|---|---|---|---|---|---|---|
| Type of fiber | | | Fiber 1 | Fiber 1 | Fiber 1 | Fiber 1 | Fiber 1 | Fiber 1 | Fiber 1 | Fiber 1 |
| Treatment | Type of processing | | Baking | Baking | Baking | Baking | Baking | Baking | Baking | Baking |
| conditions | Heating temperature(° C.) | | 180 | 180 | 180 | 180 | 180 | 180 | 180 | 180 |
| | Heating time (min) | | 1 | 1 | 1 | 1 | 1 | 1 | 1 | 1 |
| Amount | A | BIT | 0.08 | 0.1 | 0.2 | — | 0.05 | 0.05 | 0.05 | 0.05 |
| contained | | BBIT | — | — | — | 0.05 | — | — | — | — |
| (% by | X1 | DOTPAC | 1.5 | 1.5 | 1.5 | 1.5 | 0.4 | 1 | 2 | 3 |

| weight) * | Surfactant 1 | — | — | — | — | — | — | — | — |
|---|---|---|---|---|---|---|---|---|---|
| | Binder 1 | — | — | — | — | — | — | — | — |
| X1/A(Weight basis) | | 18.8 | 15 | 7.5 | 30 | 8 | 20 | 40 | 60 |
| Number of times of home | | 10 | 10 | 10 | 10 | 10 | 10 | 10 | 10 |
| washing at 40° C. | | | | | | | | | |
| Evaluation | Change in appearance | None | None | None | None | None | None | None | None |
| result | and texture of fiber | | | | | | | | |
| | Antibacterial property 1 | Effective | Effective | Effective | Effective | Effective | Effective | Effective | Effective |
| | (Staphylococcus aureus) | | | | | | | | |
| | Antibacterial property 2 | Effective | Effective | Effective | Effective | Effective | Effective | Effective | Effective |
| | (Klebsiella pneumoniae) | | | | | | | | |
| | Antifungal property | Effective | Effective | Effective | Effective | Effective | Effective | Effective | Effective |
| | (Penicillium citrinum) | | | | | | | | |

The above results show that the products of Examples 1 to 12 all have excellent antibacterial properties with excellent washing durability. In particular, although the isothiazole antibacterial agent (A) is contained at a very low concentration of 0.01 to 0.2% by weight relative to the fiber weight, excellent antibacterial and antifungal properties are exhibited because of the synergistic effect with X1 used in combination, indicating that the antibacterial fiber structure is skin-friendly.

On the other hand, in the product of Comparative Example 1 in which only the isothiazole antibacterial agent (A) is used at a low concentration and X1 is not used, it is found that sufficient antibacterial and antifungal properties are not obtained. Further, it is found that the fiber is colored in the product of Comparative Example 2 treated with the isothiazole antibacterial agent (A) alone at a concentration that provides sufficient antibacterial and antifungal properties. There is concern about adverse effects on the skin.

Furthermore, it is found that sufficient antibacterial and antifungal properties are not obtained in the product of Comparative Example 3 in which only X1 is used and the isothiazole antibacterial agent (A) is not used.

### Examples 13 to 24, Comparative Examples 4 and 5

### <Combination of Antibacterial Agent (A) and Antibacterial Agent (B) X2>

The desired treated products were obtained by performing antibacterial treatment on the fiber structures under the treatment conditions listed in Tables 3 and 4 below. These products of Examples 13 to 24 and Comparative Examples 4 and 5 were evaluated as described above, and the results are listed in Tables 3 and 4 below.

TABLE 3

| | | | Comparative | Comparative | | | | | |
|---|---|---|---|---|---|---|---|---|---|
| | | | Example 4 | Example 5 | Example 13 | Example 14 | Example 15 | Example 16 | Example 17 |
| Type of fiber | | | Fiber 1 | Fiber 1 | Fiber 1 | Fiber 1 | Fiber 1 | Fiber 1 | Fiber 1 |
| Treatment | Type of processing | | Exhaustion | Exhaustion | Exhaustion | Exhaustion | Exhaustion | Exhaustion | Exhaustion |
| conditions | | | method | method | method | method | method | method | method |
| | Heating temperature(° C.) | | 130 | 130 | 130 | 130 | 130 | 130 | 130 |
| | Heating time (min) | | 30 | 30 | 30 | 30 | 30 | 30 | 30 |
| Amount | A | BIT | — | — | 0.01 | 0.025 | 0.03 | 0.05 | 0.08 |
| contained | | BBIT | — | — | — | — | — | — | — |
| (% by | X2 | IPBC | 0.2 | 2 | 0.7 | 0.7 | 0.7 | 0.7 | 0.7 |

| weight) * | Surfactant 1 | — | — | — | — | — | — | — |
|---|---|---|---|---|---|---|---|---|
| | Binder 1 | — | — | — | — | — | — | — |
| X2/A(Weight basis) | | — | — | 70 | 28 | 23.3 | 14 | 8.8 |
| Number of times of home | | 10 | 10 | 10 | 10 | 10 | 10 | 10 |
| washing at 40° C. | | | | | | | | |
| Evaluation | Change in appearance | None | None | None | None | None | None | None |
| result | and texture of fiber | | | | | | | |
| | Antibacterial property 1 | Ineffective | Effective | Effective | Effective | Effective | Effective | Effective |
| | (Staphylococcus aureus) | | | | | | | |
| | Antibacterial property 2 | Ineffective | Ineffective | Effective | Effective | Effective | Effective | Effective |
| | (Klebsiella pneumoniae) | | | | | | | |
| | Antifungal property | Ineffective | Ineffective | Effective | Effective | Effective | Effective | Effective |
| | (Penicillium citrinum) | | | | | | | |

TABLE 4

| | | | Example 18 | Example 19 | Example 20 | Example 21 | Example 22 | Example 23 | Example 24 |
|---|---|---|---|---|---|---|---|---|---|
| Type of fiber | | | Fiber 1 | Fiber 1 | Fiber 1 | Fiber 1 | Fiber 1 | Fiber 1 | Fiber 1 |
| Treatment | Type of processing | | Exhaustion | Exhaustion | Exhaustion | Exhaustion | Exhaustion | Exhaustion | Exhaustion |
| conditions | | | method | method | method | method | method | method | method |
| | Heating temperature(° C.) | | 130 | 130 | 130 | 130 | 130 | 130 | 130 |
| | Heating time (min) | | 30 | 30 | 30 | 30 | 30 | 30 | 30 |
| Amount | A | BIT | 0.1 | 0.2 | — | 0.05 | 0.05 | 0.05 | 0.05 |
| contained | | BBIT | — | — | 0.05 | — | — | — | — |
| (% by | X2 | IPBC | 0.7 | 0.7 | 0.7 | 0.2 | 0.3 | 0.8 | 1.0 |

| weight) * | Surfactant 1 | — | 0.1 | — | — | — | — | — |
|---|---|---|---|---|---|---|---|---|
| | Binder 1 | — | — | — | — | — | — | — |
| X2/A(Weight basis) | | 7 | 3.5 | 14 | 4 | 6 | 16 | 20 |
| Number of times of home | | 10 | 10 | 10 | 10 | 10 | 10 | 10 |
| washing at 40° C. | | | | | | | | |
| Evaluation | Change in appearance | None | None | None | None | None | None | None |
| result | and texture of fiber | | | | | | | |
| | Antibacterial property 1 | Effective | Effective | Effective | Effective | Effective | Effective | Effective |
| | (Staphylococcus aureus) | | | | | | | |
| | Antibacterial property 2 | Effective | Effective | Effective | Effective | Effective | Effective | Effective |
| | (Klebsiella pneumoniae) | | | | | | | |
| | Antifungal property | Effective | Effective | Effective | Effective | Effective | Effective | Effective |
| | (Penicillium citrinum) | | | | | | | |

The above results show that the products of Examples 13 to 24 all have excellent antibacterial and antifungal properties with excellent washing durability. In particular, although the isothiazole antibacterial agent (A) is contained at a very low concentration of 0.01 to 0.2% by weight relative to the fiber weight, excellent antibacterial and antifungal properties are exhibited because of the synergistic effect with X2 used in combination, indicating that the antibacterial fiber structure is skin-friendly.

On the other hand, it is found that in the products of Comparative Examples 4 and 5 in which only X2 is used and the isothiazole antibacterial agent (A) is not used, sufficient antibacterial and antifungal properties are not obtained.

### Examples 25 to 42, Comparative Examples 6 to 9

### <Combination of Antibacterial Agent (A) and Antibacterial Agent (B) X3>

The desired treated products were obtained by performing antibacterial treatment on the fiber structures under the treatment conditions listed in Tables 5 to 7 below. These products of Examples 25 to 42 and Comparative Examples 6 to 9 were evaluated as described above, and the results are listed in Tables 5 to 7 below.

TABLE 5

| | | | Comparative | Comparative | Comparative | Comparative | | | |
|---|---|---|---|---|---|---|---|---|---|
| | | | Example 6 | Example 7 | Example 8 | Example 9 | Example 25 | Example 26 | Example 27 |
| Type of fiber | | | Fiber 1 | Fiber 1 | Fiber 1 | Fiber 1 | Fiber 1 | Fiber 1 | Fiber 1 |
| Treatment | Type of processing | | Baking | Baking | Baking | Baking | Baking | Baking | Baking |
| conditions | Heating temperature(° C.) | | 180 | 180 | 180 | 180 | 180 | 180 | 180 |
| | Heating time (min) | | 1 | 1 | 1 | 1 | 1 | 1 | 1 |
| Amount | A | BIT | — | — | — | — | 0.01 | 0.015 | 0.02 |
| contained | | BBIT | — | — | — | — | — | — | — |
| (% by | X3 | Silver nitrate | 0.002 | 0.006 | — | — | 0.002 | 0.002 | 0.002 |
| weight) * | | Silver chloride | — | — | 0.002 | 0.02 | — | — | — |

| | Surfactant 1 | — | — | — | — | — | — | — |
|---|---|---|---|---|---|---|---|---|
| | Binder 1 | — | — | — | — | — | — | — |
| X3/A(Weight basis) | | — | — | — | — | 0.2 | 0.13 | 0.1 |
| Number of times of home | | 10 | 10 | 10 | 10 | 10 | 10 | 10 |
| washing at 40° C. | | | | | | | | |
| Evaluation | Change in appearance | Slightly red | Slightly red | None | Light brown | None | None | None |
| result | and texture of fiber | | | | | | | |
| | Antibacterial property 1 | Ineffective | Effective | Ineffective | Effective | Effective | Effective | Effective |
| | (Staphylococcus aureus) | | | | | | | |
| | Antibacterial property 2 | Ineffective | Effective | Ineffective | Effective | Effective | Effective | Effective |
| | (Klebsiella pneumoniae) | | | | | | | |
| | Antifungal property | Ineffective | Effective | Ineffective | Effective | Effective | Effective | Effective |
| | (Penicillium citrinum) | | | | | | | |

TABLE 6

| | | | Example 28 | Example 29 | Example 30 | Example 31 | Example 32 | Example 33 | Example 34 |
|---|---|---|---|---|---|---|---|---|---|
| Type of fiber | | | Fiber 1 | Fiber 1 | Fiber 1 | Fiber 1 | Fiber 1 | Fiber 1 | Fiber4 |
| Treatment | Type of processing | | Baking | Baking | Baking | Baking | Baking | Baking | Baking |
| conditions | Heating temperature(° C.) | | 180 | 180 | 180 | 180 | 180 | 180 | 180 |
| | Heating time (min) | | 1 | 1 | 1 | 1 | 1 | 1 | 1 |
| Amount | A | BIT | 0.025 | 0.03 | 0.08 | 0.2 | — | — | 0.025 |
| contained | | BBIT | — | — | — | — | 0.025 | 0.025 | — |
| (% by | X3 | Silver nitrate | 0.002 | 0.002 | 0.002 | 0.002 | 0.002 | — | 0.0001 |
| weight) * | | Silver chloride | — | — | — | — | — | 0.001 | — |

| | Surfactant 1 | — | — | — | — | — | — | — |
|---|---|---|---|---|---|---|---|---|
| | Binder 1 | — | — | — | — | — | — | — |
| X3/A(Weight basis) | | 0.08 | 0.07 | 0.03 | 0.01 | 0.08 | 0.04 | 0.004 |
| Number of times of home | | 10 | 10 | 10 | 10 | 10 | 10 | 10 |
| washing at 40° C. | | | | | | | | |
| Evaluation | Change in appearance | None | None | None | None | None | None | None |
| result | and texture of fiber | | | | | | | |
| | Antibacterial property 1 | Effective | Effective | Effective | Effective | Effective | Effective | Effective |
| | (Staphylococcus aureus) | | | | | | | |
| | Antibacterial property 2 | Effective | Effective | Effective | Effective | Effective | Effective | Effective |
| | (Klebsiella pneumoniae) | | | | | | | |
| | Antifungal property | Effective | Effective | Effective | Effective | Effective | Effective | Effective |
| | (Penicillium citrinum) | | | | | | | |

TABLE 7

| | | | Example | Example | Example | Example | Example | Example | Example | Example |
|---|---|---|---|---|---|---|---|---|---|---|
| | | | 35 | 36 | 37 | 38 | 39 | 40 | 41 | 42 |
| Type of fiber | | | Fiber 1 | Fiber 1 | Fiber 1 | Fiber 1 | Fiber 1 | Fiber 1 | Fiber 1 | Fiber 5 |
| Treatment | Type of processing | | Baking | Baking | Baking | Exhaustion | Exhaustion | Exhaustion | Exhaustion | Baking |
| conditions | | | | | | method | method | method | method | |
| | Heating | | 180 | 180 | 180 | 130 | 130 | 130 | 130 | 180 |
| | temperature(° C.) | | | | | | | | | |
| | Heating time (min) | | 1 | 1 | 1 | 30 | 30 | 30 | 30 | 1 |
| Amount | A | BIT | 0.025 | 0.025 | 0.025 | 0.025 | 0.025 | 0.025 | 0.025 | 0.025 |
| contained | | BBIT | — | — | — | — | — | — | — | — |
| (% by | X3 | Silver | 0.001 | 0.008 | 0.01 | — | — | — | — | 0.0005 |
| weight) * | | nitrate | | | | | | | | |
| | | Silver | — | — | — | 0.0005 | 0.0002 | 0.002 | 0.005 | — |
| | | chloride | | | | | | | | |

| | Surfactant 1 | — | — | — | — | — | — | — | — |
|---|---|---|---|---|---|---|---|---|---|
| | Binder 1 | — | — | — | — | — | — | — | — |
| X3/A(Weight basis) | | 0.04 | 0.32 | 0.4 | 0.02 | 0.008 | 0.08 | 0.2 | 0.02 |
| Number of times of home | | 10 | 10 | 10 | 10 | 10 | 10 | 10 | 10 |
| washing at 40° C. | | | | | | | | | |
| Evaluation | Change in appearance | None | None | None | None | None | None | None | None |
| result | and texture of fiber | | | | | | | | |
| | Antibacterial property 1 | Effective | Effective | Effective | Effective | Effective | Effective | Effective | Effective |
| | (Staphylococcus aureus) | | | | | | | | |
| | Antibacterial property 2 | Effective | Effective | Effective | Effective | Effective | Effective | Effective | Effective |
| | (Klebsiella pneumoniae) | | | | | | | | |
| | Antifungal property | Effective | Effective | Effective | Effective | Effective | Effective | Effective | Effective |
| | (Penicillium citrinum) | | | | | | | | |

The above results show that the products of Examples 25 to 42 all have excellent antibacterial properties with excellent washing durability. In particular, although the isothiazole antibacterial agent (A) is contained at a very low concentration of 0.01 to 0.2% by weight relative to the fiber weight, excellent antibacterial and antifungal properties are exhibited because of the synergistic effect with X3 used in combination, indicating that the antibacterial fiber structure is skin-friendly.

On the other hand, it is found that in the products of Comparative Examples 6 and 8 in which only X3 is used at a low concentration and the isothiazole antibacterial agent (A) is not used, sufficient antibacterial and antifungal properties are not obtained, and in the products of Comparative Examples 7 and 9 in which only X3 is used at a high concentration, antibacterial and antifungal properties are obtained but the fiber is colored.

### Examples 43 to 54, Comparative Examples 10 and 11

### <Combination of Antibacterial Agent (A) and Antibacterial Agent (B) X4>

The desired treated products were obtained by performing antibacterial treatment on the fiber structures under the treatment conditions listed in Tables 8 and 9 below. These products of Examples 43 to 54 and Comparative Examples 10 and 11 were evaluated as described above, and the results are listed in Tables 8 and 9 below.

TABLE 8

| | | | Comparative | Comparative | | | | | |
|---|---|---|---|---|---|---|---|---|---|
| | | | Example 10 | Example 11 | Example 43 | Example 44 | Example 45 | Example 46 | Example 47 |
| Type of fiber | | | Fiber 1 | Fiber 1 | Fiber 1 | Fiber 1 | Fiber 1 | Fiber 1 | Fiber 1 |
| Treatment | Type of processing | | Baking | Baking | Baking | Baking | Baking | Baking | Baking |
| conditions | Heating temperature(° C.) | | 180 | 180 | 180 | 180 | 180 | 180 | 180 |
| | Heating time (min) | | 1 | 1 | 1 | 1 | 1 | 1 | 1 |
| Amount | A | BIT | — | — | 0.01 | 0.015 | 0.02 | 0.025 | 0.03 |
| contained | | BBIT | — | — | — | — | — | — | — |
| (% by | X4 | Titanium oxide | 0.002 | 0.2 | 0.002 | 0.002 | 0.002 | 0.002 | 0.002 |

| weight) * | Surfactant 1 | — | — | — | — | — | — | — |
|---|---|---|---|---|---|---|---|---|
| | Binder 1 | — | — | — | — | — | — | — |
| X4/A(Weight basis) | | — | — | 0.2 | 0.14 | 0.1 | 0.08 | 0.07 |
| Number of times of home | | 10 | 10 | 10 | 10 | 10 | 10 | 10 |
| washing at 40° C. | | | | | | | | |
| Evaluation | Change in appearance | Colored | Colored + | None | None | None | None | None |
| result | and texture of fiber | | stiff | | | | | |
| | Antibacterial property 1 | Ineffective | Effective | Effective | Effective | Effective | Effective | Effective |
| | (Staphylococcus aureus) | | | | | | | |
| | Antibacterial property 2 | Ineffective | Effective | Effective | Effective | Effective | Effective | Effective |
| | (Klebsiella pneumoniae) | | | | | | | |
| | Antifungal property | Ineffective | Effective | Effective | Effective | Effective | Effective | Effective |
| | (Penicillium citrinum) | | | | | | | |

TABLE 9

| | | | Example 48 | Example 49 | Example 50 | Example 51 | Example 52 | Example 53 | Example 54 |
|---|---|---|---|---|---|---|---|---|---|
| Type of fiber | | | Fiber 1 | Fiber 1 | Fiber 1 | Fiber 1 | Fiber 1 | Fiber 1 | Fiber 1 |
| Treatment | Type of processing | | Baking | Baking | Baking | Baking | Baking | Baking | Baking |
| conditions | Heating temperature(° C.) | | 180 | 180 | 180 | 180 | 180 | 180 | 180 |
| | Heating time (min) | | 1 | 1 | 1 | 1 | 1 | 1 | 1 |
| Amount | A | BIT | 0.08 | 0.2 | — | 0.025 | 0.025 | 0.025 | 0.025 |
| contained | | BBIT | — | — | 0.025 | — | — | — | — |
| (% by | X4 | Titanium oxide | 0.002 | 0.002 | 0.002 | 0.0001 | 0.008 | 0.01 | 0.02 |

| weight) * | Surfactant 1 | — | — | — | — | — | — | — |
|---|---|---|---|---|---|---|---|---|
| | Binder 1 | — | — | — | — | — | — | — |
| X4/A(Weight basis) | | 0.03 | 0.01 | 0.08 | 0.004 | 0.32 | 0.4 | 0.8 |
| Number of times of home | | 10 | 10 | 10 | 10 | 10 | 10 | 10 |
| washing at 40° C. | | | | | | | | |
| Evaluation | Change in appearance | None | None | None | None | None | None | None |
| result | and texture of fiber | | | | | | | |
| | Antibacterial property 1 | Effective | Effective | Effective | Effective | Effective | Effective | Effective |
| | (Staphylococcus aureus) | | | | | | | |
| | Antibacterial property 2 | Effective | Effective | Effective | Effective | Effective | Effective | Effective |
| | (Klebsiella pneumoniae) | | | | | | | |
| | Antifungal property | Effective | Effective | Effective | Effective | Effective | Effective | Effective |
| | (Penicillium citrinum) | | | | | | | |

The above results show that the products of Examples 43 to 54 all have excellent antibacterial properties with excellent washing durability. In particular, although the isothiazole antibacterial agent (A) is contained at a very low concentration of 0.01 to 0.2% by weight relative to the fiber weight, excellent antibacterial and antifungal properties are exhibited because of the synergistic effect with X4 used in combination, indicating that the antibacterial fiber structure is skin-friendly.

On the other hand, it is found that in the product of Comparative Example 10 in which only X4 is used at a low concentration and the isothiazole antibacterial agent (A) is not used, the fiber is colored and moreover, sufficient antibacterial and antifungal properties are not obtained. It is found that in the product of Comparative Example 11 in which only X4 is used at a high concentration, antibacterial and antifungal properties are obtained, but the fiber is colored and feels stiff.

### Examples 55 to 70

### <Various Combinations of Antibacterial Agent (A) and Antibacterial Agent (B)>

The desired treated products were obtained by performing antibacterial treatment on the fiber structures under the treatment conditions listed in Tables 10 and 11 below. These products of Examples 55 to and 70 were evaluated as described above, and the results are listed in Tables 10 and 11 below.

TABLE 10

| | | | Example | Example | Example | Example | Example | Example | Example | Example |
|---|---|---|---|---|---|---|---|---|---|---|
| | | | 55 | 56 | 57 | 58 | 59 | 60 | 61 | 62 |
| Type of fiber | | | Fiber 1 | Fiber 1 | Fiber 1 | Fiber 1 | Fiber 1 | Fiber 1 | Fiber 1 | Fiber 5 |
| Treatment | Type of processing | | Baking | Baking | Baking | Baking | Baking | Baking | Baking | Baking |
| conditions | Heating | | 160 | 160 | 140 | 140 | 200 | 160 | 140 | 180 |
| | temperature(° C.) | | | | | | | | | |
| | Heating time (min) | | 1 | 1 | 1 | 1 | 1 | 1 | 1 | 1 |
| Amount | A | BIT | 0.05 | 0.05 | 0.05 | 0.05 | 0.05 | 0.05 | 0.05 | 0.025 |
| contained | X1 | DOTPAC | 1.5 | 1.5 | 1.5 | 1.5 | — | — | — | — |
| (% by | X2 | IPBC | — | — | — | — | 0.7 | 0.7 | 0.7 | 0.7 |
| weight) * | X3 | Silver | — | — | — | — | — | — | — | — |
| | | nitrate | | | | | | | | |
| | | Silver | — | — | — | — | — | — | — | — |
| | | chloride | | | | | | | | |

| | Surfactant 1 | — | — | — | — | — | — | — | — |
|---|---|---|---|---|---|---|---|---|---|
| | Binder 1 | — | — | — | — | — | — | — | — |
| Number of times of home | | 10 | 50 | 10 | 50 | 10 | 10 | 10 | 10 |
| washing at 40° C. | | | | | | | | | |
| Evaluation | Change in appearance | None | None | None | None | None | None | None | None |
| result | and texture of fiber | | | | | | | | |
| | Antibacterial property 1 | Effective | Effective | Effective | Effective | Effective | Effective | Effective | Effective |
| | (Staphylococcus aureus) | | | | | | | | |
| | Antibacterial property 2 | Effective | Effective | Effective | Ineffective | Effective | Effective | Effective | Effective |
| | (Klebsiella pneumoniae) | | | | | | | | |
| | Antifungal property | Effective | Effective | Effective | Ineffective | Effective | Effective | Effective | Effective |
| | (Penicillium citrinum) | | | | | | | | |

TABLE 11

| | | | Example | Example | Example | Example | Example | Example | Example | Example |
|---|---|---|---|---|---|---|---|---|---|---|
| | | | 63 | 64 | 65 | 66 | 67 | 68 | 69 | 70 |
| Type of fiber | | | Fiber 1 | Fiber 1 | Fiber 1 | Fiber 1 | Fiber 1 | Fiber 1 | Fiber 1 | Fiber 1 |
| Treatment | Type of processing | | Baking | Baking | Baking | Baking | Baking | Baking | Baking | Baking |
| conditions | Heating | | 220 | 160 | 140 | 140 | 200 | 160 | 140 | 180 |
| | temperature(° C.) | | | | | | | | | |
| | Heating time (min) | | 1 | 1 | 1 | 1 | 1 | 1 | 1 | 1 |
| Amount | A | BIT | 0.025 | 0.025 | 0.025 | 0.025 | 0.025 | 0.025 | 0.025 | 0.025 |
| contained | X1 | DOTPAC | — | — | — | — | — | — | — | — |
| (% by | X2 | IPBC | — | — | — | — | — | — | — | — |
| weight) * | X3 | Silver | 0.002 | 0.002 | 0.002 | 0.002 | — | 0.0001 | — | — |
| | | nitrate | | | | | | | | |
| | | Silver | — | — | — | — | 0.005 | — | 0.02 | 0.02 |
| | | chloride | | | | | | | | |

| | Surfactant 1 | — | — | — | — | — | — | — | — |
|---|---|---|---|---|---|---|---|---|---|
| | Binder 1 | — | — | — | — | — | — | — | 0.04 |
| Number of times of home | | 10 | 50 | 10 | 50 | 10 | 10 | 10 | 10 |
| washing at 40° C. | | | | | | | | | |
| Evaluation | Change in appearance | None | None | None | None | None | None | None | Slightly stiff |
| result | and texture of fiber | | | | | | | | |
| | Antibacterial property 1 | Effective | Effective | Effective | Effective | Effective | Effective | Effective | Effective |
| | (Staphylococcus aureus) | | | | | | | | |
| | Antibacterial property 2 | Effective | Effective | Effective | Ineffective | Effective | Effective | Effective | Effective |
| | (Klebsiella pneumoniae) | | | | | | | | |
| | Antifungal property | Effective | Effective | Effective | Ineffective | Effective | Effective | Effective | Effective |
| | (Penicillium citrinum) | | | | | | | | |

The above results show that the products of Examples 55 to 70 mostly have excellent antibacterial and antifungal properties with excellent washing durability.

In the product of Example 58 in which the temperature in the baking is as low as 140° C., antibacterial and antifungal properties decrease after 50 times of washing, indicating that the washing durability is not sufficient. However, it can be said that the product processed under the same treatment conditions and evaluated after 10 times of washing (the product of Example 57) has excellent antibacterial and antifungal properties and is sufficiently practical for some applications.

It is found that the product of Example 70 using a binder has excellent antibacterial and antifungal properties, but the texture is somewhat stiff.

In the above examples, specific forms in the present disclosure have been shown. However, the above examples are merely illustrative and are not to be construed as limiting. Various modifications apparent to those skilled in the art are intended to be within the scope of the present disclosure.

### INDUSTRIAL APPLICABILITY

The present disclosure is useful in providing an excellent antibacterial fiber structure that does not adversely affect the quality of fiber or the skin in contact with the fiber, because the synergistic effect of the antibacterial agent (A) and the antibacterial agent (B) provides excellent antibacterial properties with washing durability as a whole despite a relatively low content of each of the combined antibacterial agents.

1. An antibacterial fiber structure comprising a synthetic fiber,
wherein an isothiazole antibacterial agent (A), and
at least one antibacterial agent (B) belonging to any of the following antibacterial agent groups X1 to X4 immobilized to the synthetic fiber,
wherein the isothiazole antibacterial agent (A) is contained in an amount of 0.01 to 0.2% by weight in the entire fiber structure:
X1: organosilicon quaternary ammonium salt
X2: carbamic acid ester derivative
X3: silver antibacterial agent
X4: metal oxide excluding silver oxide.

2. The antibacterial fiber structure according to claim 1, wherein the antibacterial fiber structure has an antibacterial activity value of 2.2 or more against both Staphylococcus aureus and Klebsiella pneumoniae as measured in accordance with JIS L1902:2015 after 10 times of home washing performed in accordance with JIS L0217-103.

3. The antibacterial fiber structure according to claim 1, wherein the isothiazole antibacterial agent (A) is a benzoisothiazolin derivative.

4. The antibacterial fiber structure according to claim 1, wherein the organosilicon quaternary ammonium salt of X1 is n-octadecyldimethyl[3-(trimethoxysilyl)propyl]ammonium chloride.

5. The antibacterial fiber structure according to claim 1, wherein the carbamic acid ester derivative of X2 is 3-iodo-2-propynyl-N-butylcarbamate.

6. The antibacterial fiber structure according to claim 1, wherein the silver antibacterial agent of X3 is at least one of silver nitrate, silver chloride, silver sulfate, and silver oxide.

7. The antibacterial fiber structure according to claim 1, wherein the metal oxide of X4 is at least one of titanium oxide and zinc oxide.

8. A method for producing the antibacterial fiber structure according to claim 1, the method comprising:
impregnating a fiber structure comprising a synthetic fiber with an aqueous treatment liquid comprising
an isothiazole antibacterial agent (A), and
at least one antibacterial agent (B) belonging to any of the following antibacterial agent groups X1 to X4; and
performing thermal treatment at 90° C. or higher and 200° C. or lower to obtain a fiber structure in which the isothiazole antibacterial agent (A) and the antibacterial agent (B) are immobilized to the fiber:
X1: organosilicon quaternary ammonium salt
X2: carbamic acid ester derivative
X3: silver antibacterial agent
X4: metal oxide excluding silver oxide.

9. The method for producing the antibacterial fiber structure according to claim 8, wherein the thermal treatment is a heating process at 100 to 200° C. under normal pressure.

10. The method for producing the antibacterial fiber structure according to claim 8, wherein the thermal treatment is a heating process at 90 to 150° C. under pressure.

11. The antibacterial fiber structure according to claim 2, wherein the isothiazole antibacterial agent (A) is a benzoisothiazolin derivative.

12. The antibacterial fiber structure according to claim 2, wherein the organosilicon quaternary ammonium salt of X1 is n-octadecyldimethyl[3-(trimethoxysilyl)propyl]ammonium chloride.

13. The antibacterial fiber structure according to claim 2, wherein the carbamic acid ester derivative of X2 is 3-iodo-2-propynyl-N-butylcarbamate.

14. The antibacterial fiber structure according to claim 2, wherein the silver antibacterial agent of X3 is at least one of silver nitrate, silver chloride, silver sulfate, and silver oxide.

15. The antibacterial fiber structure according to claim 2, wherein the metal oxide of X4 is at least one of titanium oxide and zinc oxide.

16. A method for producing the antibacterial fiber structure according to claim 2, the method comprising:
impregnating a fiber structure comprising a synthetic fiber with an aqueous treatment liquid comprising
an isothiazole antibacterial agent (A), and
at least one antibacterial agent (B) belonging to any of the following antibacterial agent groups X1 to X4; and
performing thermal treatment at 90° C. or higher and 200° C. or lower to obtain a fiber structure in which the isothiazole antibacterial agent (A) and the antibacterial agent (B) are immobilized to the fiber:
X1: organosilicon quaternary ammonium salt
X2: carbamic acid ester derivative
X3: silver antibacterial agent
X4: metal oxide excluding silver oxide.

17. The method for producing the antibacterial fiber structure according to claim 16, wherein the thermal treatment is a heating process at 100 to 200° C. under normal pressure.

18. The method for producing the antibacterial fiber structure according to claim 16, wherein the thermal treatment is a heating process at 90 to 150° C. under pressure.
